(19) United States
(12) Patent Application Publication
(10) Pub. No.: US 2016/0026862 A1
(43) Pub. Date: Jan. 28, 2016

(54) EYE REFLECTED CONTENT FOR VERIFICATION OF USER LIVELINESS

(71) Applicant: INTEL CORPORATION, Santa Clara, CA (US)

(72) Inventor: Glen J. Anderson, Beaverton, OR (US)

(73) Assignee: Intel Corporation, Santa Clara, CA (US)

(21) Appl. No.: 14/361,915

(22) PCT Filed: Dec. 9, 2013
(86) PCT No.: PCT/US2013/073896

§ 371 Date: May 30, 2014

(51) Int. Cl. G06K 9/00; G06T 7/40; H04N 5/232; G06T 7/00

(52) U.S. Cl. CPC G06K 9/00604; G06T 7/0081; G06T 7/408; H04N 5/23229; G06T 2207/10024; G06T 2207/30201

(57) ABSTRACT

Generally, this disclosure provides devices, systems and methods for improved verification of user liveliness based on detection and identification of a corneal image reflection from the user. The system may include a security image generation module to provide a security image for presentation to the user on a client system display element; a corneal reflection analysis module to estimate features of a corneal reflected image, the corneal reflected image extracted from an image of the user obtained by a camera of the client system; and the corneal reflection analysis module further configured to verify liveliness of the user based on a match between the corneal reflected image and the security image, the match based on the estimated features.

### FIELD

The present disclosure relates to verification of user liveliness, and more particularly, to improved verification of user liveliness based on detection and identification of a corneal image reflection from the user.

### BACKGROUND

Providers of secure data content, such as financial institutions or the like, often require some form of user authentication, prior to the release of data to the user, as one component of a security system. This may be particularly true where the user is accessing the secure data server from a remote client system. The authentication process may involve one or more types of verification tests that may be more or less onerous to the user depending on the level of security required. It is generally desirable to employ authentication methods that require as little action from the user as possible while still ensuring that the user is a live person as opposed to an automated system attempting to spoof verification. Some existing systems require the user to perform gestures or motions for camera based authentication to demonstrate user liveliness. Other systems require the user to type in a randomly generated string of characters displayed by the authentication system. These techniques, however, require action on the part of the user that may be considered to be inconvenient, especially when performed repeatedly.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a top level system diagram of one example embodiment consistent with the present disclosure;

FIG. 2 illustrates a block diagram of one example embodiment consistent with the present disclosure;

FIG. 3 illustrates a block diagram of another example embodiment consistent with the present disclosure;

FIG. 4 illustrates a flowchart of operations of one example embodiment consistent with the present disclosure; and

FIG. 5 illustrates a platform of one example embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides devices, systems and methods for improved verification of user liveliness based on detection and identification of a corneal image reflection from the user, which may, for example be included in a user authentication system. The term “user liveliness,” as used herein, is employed to indicate that the user is a live person as opposed to an automated system attempting to imitate a live user, perhaps for fraudulent purposes. A secure server may be configured to provide secure data content to a user of a client device after authentication of the user including verification of user liveliness. For example, the user may log onto a web site associated with the secure server from the client device. The server's authentication system may generate a security image to be transmitted to the client device and displayed to the user. A camera, for example associated with the client device, may be configured to capture an image of the user that includes a reflection of the security image from the cornea of the eye of the user. This reflected corneal image may be transmitted back to the secure server authentication system for analysis to determine if a match exists between the reflected image and the original security image. The determination of a match may provide additional evidence and confidence that the user is a live person as opposed to an automated system, while reducing the level of effort or action required from the user. This corneal reflection image matching may be employed as an additional element of an authentication system that may also include facial recognition, eye blink detection and/or other suitable user verification techniques.

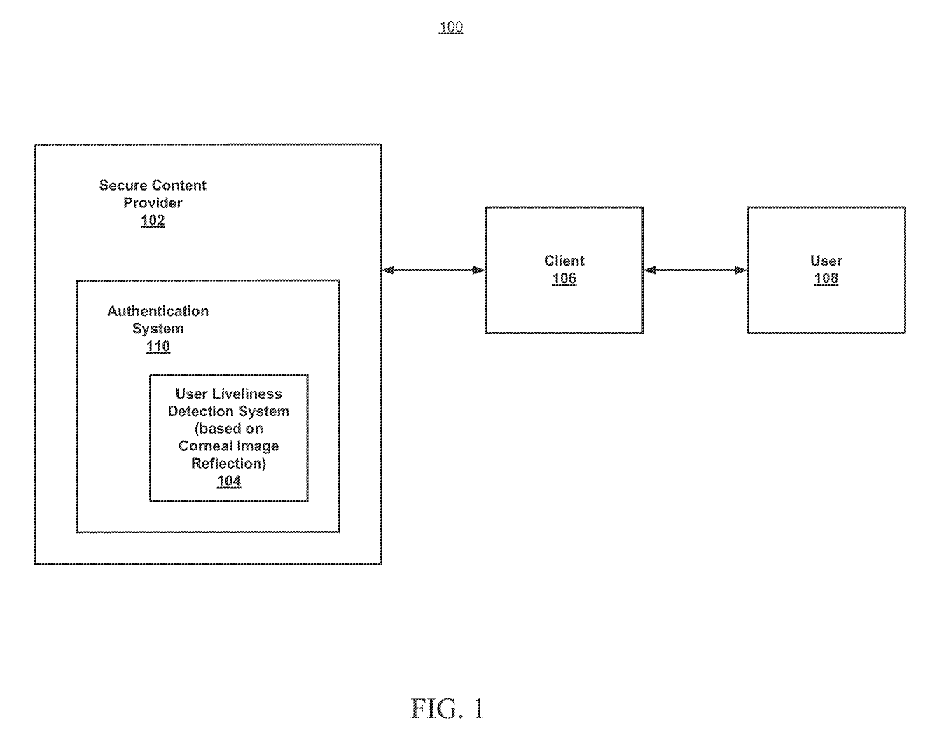

FIG. 1 illustrates a top level system diagram 100 of one example embodiment consistent with the present disclosure. A secure content provider 102 is shown to include an authentication system 110 that may further include, or work in conjunction with, a user liveliness detection system (based on corneal image reflection) 104. The secure content provider 102 may be a secure server associated with, for example, a financial institution or other organization/entity that maintains and provides restricted user access to a database of confidential information. The secure content provider 102 may communicate with a client device 106 associated with user 108. Client device 106 may be a computing device such as a workstation, laptop or Ultrabook; or any type of mobile platform or communication device including a smartphone, tablet, netbook, etc. or any other suitable device. Secure content provider 102 and client device 106 may communicate through a wired or wireless connection. In some embodiments the connection may be an internet connection and user 108 may access secure content provider 102 through a web browser.

The user liveliness detection system (based on corneal image reflection) 104 may work in conjunction with a display element and camera of the client device 106, as will be explained in greater detail below, to verify that a security image sent to the client 106 is reflected in the cornea of the user 108 as an indicator that the user is a live person.

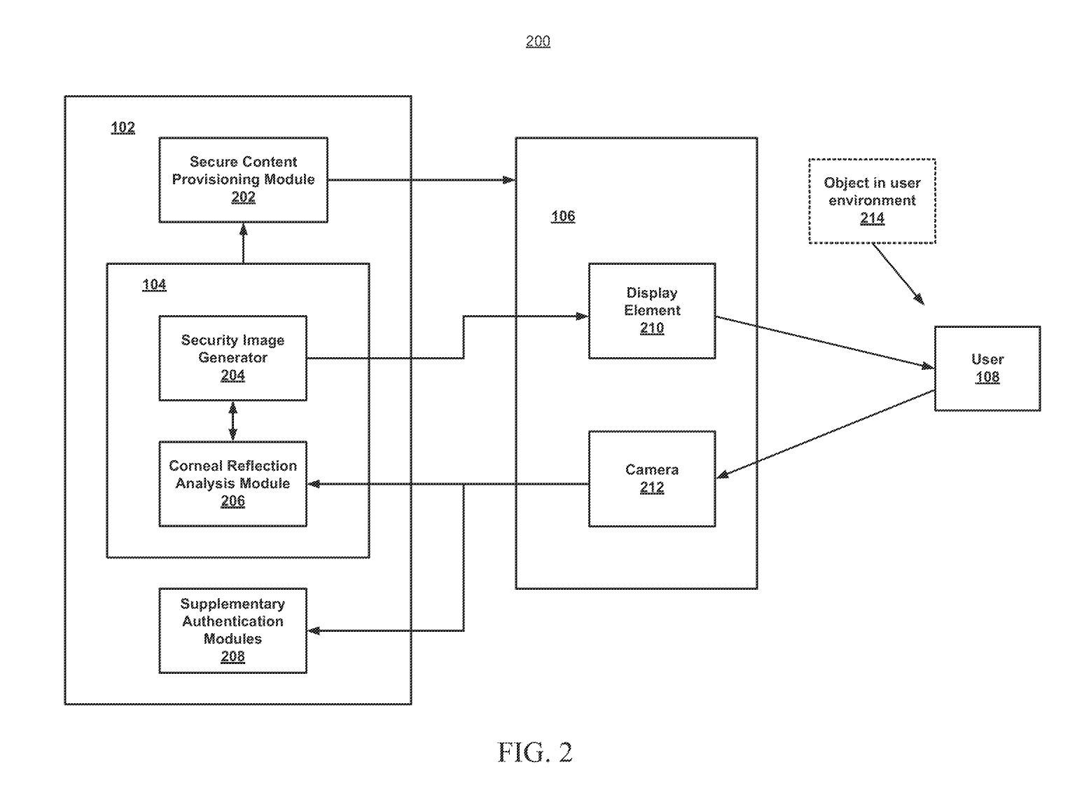

FIG. 2 illustrates a block diagram 200 of one example embodiment consistent with the present disclosure. The user liveliness detection system 104 of secure content provider 102 is shown to include a security image generator 204 and a corneal reflection analysis module 206. Secure content provider 102 is also shown to include secure content provisioning module 202, and may optionally include supplementary user authentication modules 208. Client 106 is shown to include a display element 210 and a camera 212.

Security image generator 204 may be configured to generate a random, pseudo-random or other suitable security image that is generally not known or predictable by user 108 or other entities that may attempt to deceive secure content provider 102. In some embodiments, however, the image may be known to the user 108 so that the user may also verify the authenticity of the provider, for example that the web site of the provider is not a fraudulent (also known as a “phishing”) web site designed to deceptively obtain confidential information from the user. In a more complex implementation, a combination of security images may be employed, some of which are known to the user while others are not known to the user. This may aid in achieving both purposes of frustrating deception of the provider by a fraudulent user and frustrating deception of the user by a fraudulent web site. Additionally, in some embodiments, the security image may be presented in infrared (IR), or other suitable wavelengths, not visible to the user but detectable by a camera configured to operate in those wavelength ranges (e.g., an IR camera).

In some embodiments, the security image may include a pattern, a video, a color or any other identifiable features. The image may be a single image frame or, in systems or increased complexity, a video that includes multiple image frames. In systems of reduced complexity the image may be a single block of color or some relatively small number of blocks of colors. The security image may be transmitted to Client 106, for example over a communication network or internet connection, to be presented by display element 210 for viewing by user 108. Camera 212 of client 106 may be configured to obtain images, for example facial images, of user 108 that include the regions around the user's eyes. These images may further include reflections from the user's corneas which, if the user is viewing the display element, may include a reflection of the security image being presented to the user. The corneal reflected image may be transmitted from client 106 back to the secure content provider 102 and user liveliness detection system 104.

Corneal reflection analysis module 206 may be configured to detect the presence of the security image in the corneal reflected image, as will be described in greater detail below, to verify, at least in part, the liveliness of user 108. The camera 212 may be configured to capture images at a resolution level that is sufficient to provide a detection confidence that is dependent on the required level of security and allowable system cost. In some embodiments, supplementary authentication modules 208 may also be employed to authenticate the user, based on the received user images from camera 212, with increased confidence resulting from the verification of user liveliness. These supplementary techniques may include facial recognition, blink detection, eye-tracking or other suitable techniques.

In some embodiments, an object 214, which may be present in the user's environment, will also be reflected from the user's cornea and included in the captured reflected image. This object 214 may be an identifiable object, known to the secure content provider 102, which may further serve as an indication of the user's liveliness, identity and/or location for verification and authorization purposes.

In some embodiments, the user may be required to look at images at different locations on the screen of the display element, for example in a directed sequence, while the system monitors changes in the corneal reflected image. The monitored changes should match the changes that would be expected as a live user redirects his or her view to different locations in order to verify user liveliness.

In response to a successful verification of user liveliness by module 104 and/or authentication system 110, a notification may be sent to secure content provisioning module 202 to enable release of the secure data content to the user.

In some embodiments, corneal reflection images may be recorded, stored and/or tracked, by provider 102, for each document (e.g., item of secure data) that the user views, to provide an additional layer of security and an auditing capability. For example a log may be kept to indicate the time, location and identity of a user viewing of a secure data item.

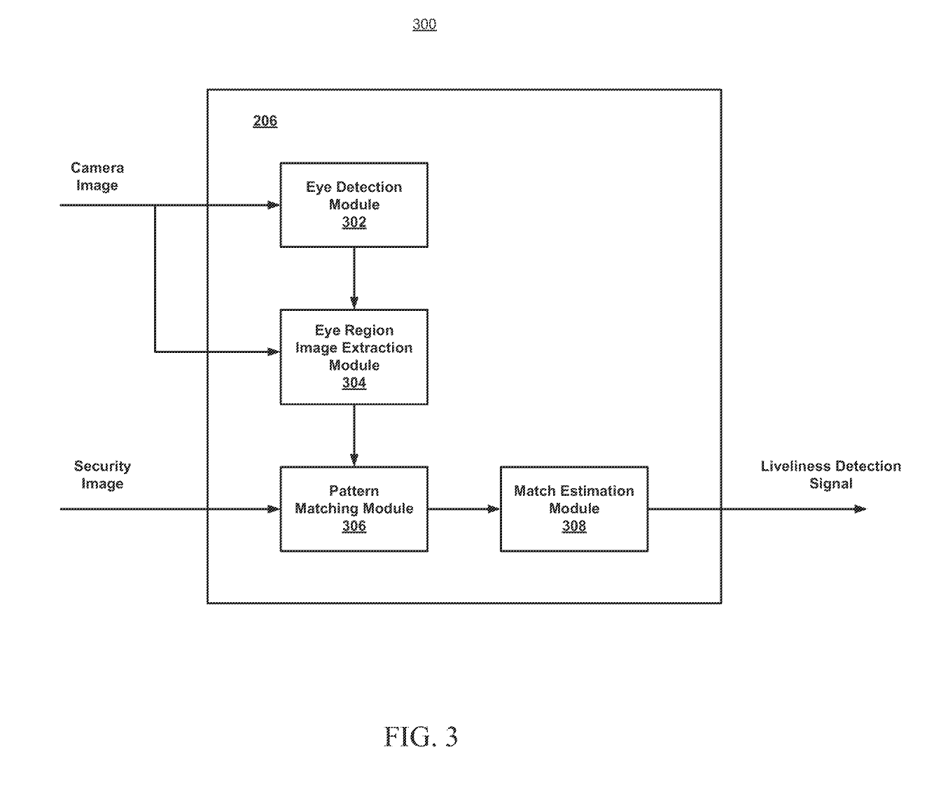

FIG. 3 illustrates a block diagram 300 of another example embodiment consistent with the present disclosure. Corneal reflection analysis module 206 is shown to include an eye detection module 302, an eye region image extraction module 304, a pattern matching module 306 and a match estimation module 308. Eye detection module may be configured to detect the presence and/or location of an eye in the received user image from camera 212. Eye region image extraction module 304 may be configured to extract a region of the received user image encompassing the detected eye and including the corneal reflected image. Pattern matching module 306 may be configured to locate, identify and/or match patterns between the corneal reflected image and the security image. Match estimation module 308 may be configured to estimate a matching likelihood, for example as a numerical confidence level of the match between the corneal reflected image and the security image. In some embodiments, the confidence level may be compared to a fixed or adjustable threshold to determine the existence of a match and the generation of liveliness detection signal to enable the release of the secure data content to the user.

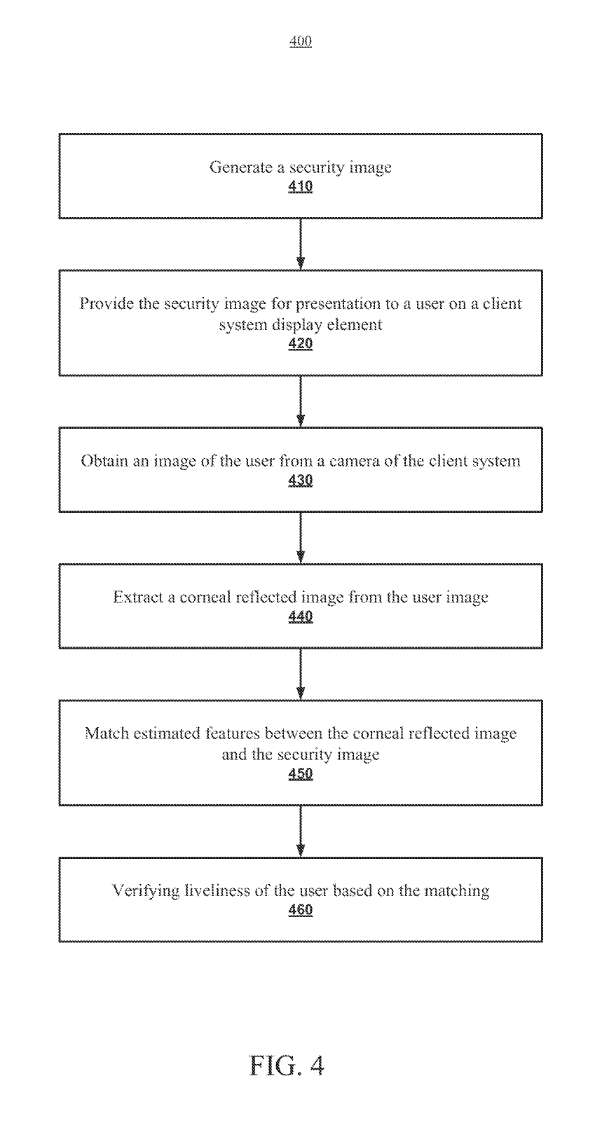

FIG. 4 illustrates a flowchart of operations 400 of one example embodiment consistent with the present disclosure for verification of user liveliness. At operation 410, a security image is generated. The image may be generated by a server system associated with a secure data content provider. At operation 420, the security image is provided for presentation to a user on a client system display element. At operation 430, an image of the user is obtained from a camera of the client system. At operation 440, a corneal reflected image is extracted from the user image. At operation 450, estimated features are matched between the corneal reflected image and the security image. The estimated features may include patterns, colors, or other identifiable features. At operation 460, liveliness of the user is verified based on the matching. In response to the authentication, secure data content may be provided to the user.

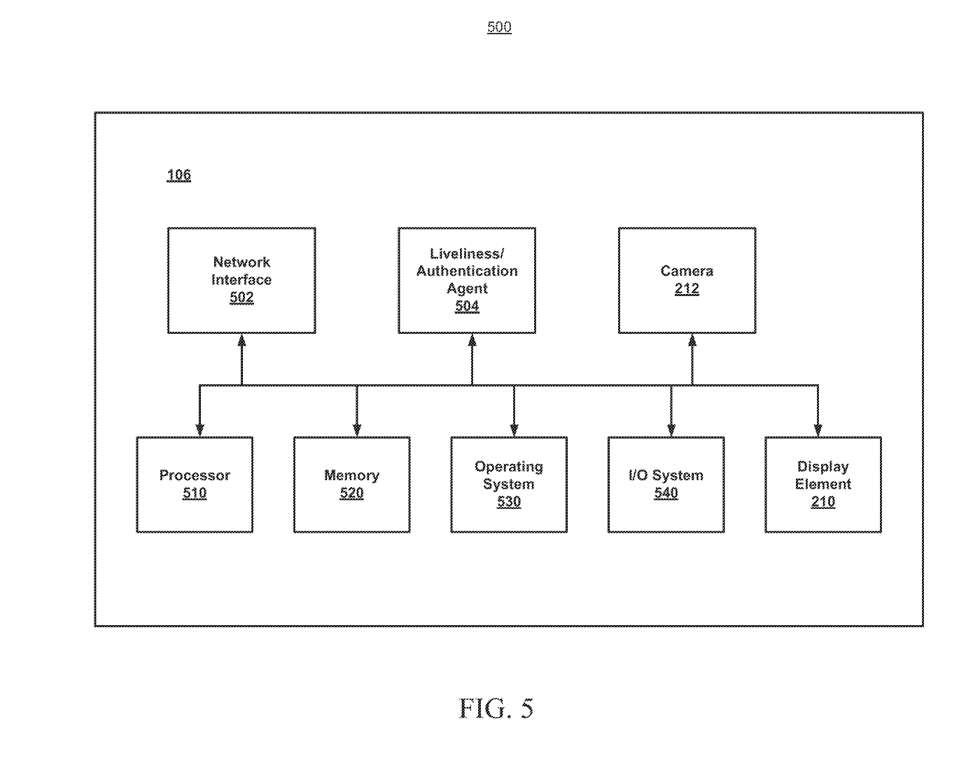

FIG. 5 illustrates a block diagram 500 of a platform consistent with one example embodiment of the present disclosure. Platform 106 is shown to include a network interface module 502, a liveliness/authentication agent (or service) module 504, a display element 210 and a camera 212, the operations of which are described herein. Platform 106 may also include a processor 510, memory 520, operating system (OS) 530, and an input/output system 540. In some embodiments the display element 210 may be a touchscreen display element, a liquid crystal display (LCD) or any other suitable display type. Network interface module 502 may be configured to provide wired or wireless communication between platform 106 and any external entities. The communications may conform to or otherwise be compatible with any existing or yet to be developed communication standards including mobile phone communication standards.

Liveliness/Authentication agent module 504 may be configured to receive the security image from secure content provider 102 and to transmit the corneal reflection image back to provider 102 for use by authentication system 110 and user liveliness detection system 104. Module 504 may also be configured to receive secure content from provider 102, after successful user authentication based at least in part on detection of user liveliness. In some embodiments, liveliness/authentication agent module 504 may be an installed application, for example an application provided by an entity associated with secure content provider 102. In some embodiments, module 504 may be a service or other component of operating system 530. In some embodiments, module 504 may be a general purpose web browser that provides a link to a web page associated with secure content provider 102, through which the operations described above are accomplished.

Examples of platform 106 may include, but are not limited to, a mobile communication device such as a cellular handset or a smartphone based on the Android® OS, iOS®, Windows® OS, Blackberry® OS, Palm® OS, Symbian® OS, etc., a mobile computing device such as a tablet computer like an iPad®, Surface®, Galaxy Tab®, Kindle Fire®, etc., an Ultrabook® including a low-power chipset manufactured by Intel Corporation, a netbook, a notebook, a laptop or a palmtop.

In platform 106, processor 510 may comprise one or more processors situated in separate components, or alternatively, one or more processing cores embodied in a single component (e.g., in a System-on-a-Chip (SoC) configuration) and any processor-related support circuitry (e.g., bridging interfaces, etc.). Example processors may include, but are not limited to, various x86-based microprocessors available from the Intel Corporation including those in the Pentium, Xeon, Itanium,

Celeron, Atom, Core i-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processor 510 may interact with other system components that may be operating at different speeds, on different buses, etc. in platform 106. Some or all of the functionality commonly associated with the support circuitry may also be included in the same physical package as the processor (e.g., such as in the Sandy Bridge family of processors available from the Intel Corporation).

It will be appreciated that in some embodiments, one or more of the components of platform 106 may be combined in a system-on-a-chip (SoC) architecture. In some embodiments, the components may be hardware components, firmware components, software components or any suitable combination of hardware, firmware or software.

Embodiments of the methods described herein may be implemented in a system that includes one or more storage mediums having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

The storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry. An “application” (app), “agent” or “service” may be embodied as code or instructions which may be executed on programmable circuitry such as a host processor or other programmable circuitry and may, in some embodiments, work in conjunction with or as a component of an Operating System. A module, as used in any embodiment herein, may be embodied as circuitry. The circuitry may be embodied as an integrated circuit, such as an integrated circuit chip.

Thus, the present disclosure provides devices, methods, systems and computer-readable storage medium for improved verification of user liveliness based on detection and identification of a corneal image reflection from the user. The following examples pertain to further embodiments.

The system may include a security image generation module to provide a security image for presentation to the user on a client system display element. The device of this example may also include a corneal reflection analysis module to estimate features of a corneal reflected image, the corneal reflected image extracted from an image of the user obtained by a camera of the client system. The corneal reflection analysis module of this example may further be configured to verify liveliness of the user based on a match between the corneal reflected image and the security image, the match based on the estimated features.

Another example system includes the forgoing components and further includes a secure content provisioning module to provide secure content to the user in response to the verification.

Another example system includes the forgoing components and the corneal reflection analysis module further includes an eye detection module to detect an eye in the user image.

Another example system includes the forgoing components and the corneal reflection analysis module further includes an eye region image extraction module to extract a region of the user image encompassing the detected eye, the extracted region including the corneal reflected image.

Another example system includes the forgoing components and the estimated features include patterns.

Another example system includes the forgoing components and the estimated features include colors.

Another example system includes the forgoing components and the corneal reflected image further includes a reflection of an object in the environment of the user, and the user liveliness verification further includes identification of the object.

Another example system includes the forgoing components and further includes a user authentication system to perform facial recognition.

Another example system includes the forgoing components and further includes a user authentication system to perform eye blink detection.

According to another aspect there is provided a method. The method may include generating a security image. The method of this example may also include providing the security image for presentation to the user on a client system display element. The method of this example may further include obtaining an image of the user from a camera of the client system. The method of this example may further include extracting a corneal reflected image from the user image. The method of this example may further include matching estimated features between the corneal reflected image and the security image. The method of this example may further include verifying liveliness of the user based on the matching.

Another example method includes the forgoing operations and further includes providing secure content to the user in response to the verification.

Another example method includes the forgoing operations and further includes detecting an eye in the user image and extracting the corneal reflected image from a region of the user image encompassing the detected eye.

Another example method includes the forgoing operations and the estimated features include patterns.

Another example method includes the forgoing operations and the estimated features include colors.

Another example method includes the forgoing operations and the corneal reflected image further includes a reflection of an object in the environment of the user, and the user liveliness verification further includes identifying the object.

Another example method includes the forgoing operations and further includes directing the user to sequentially view a plurality of locations of the display element and obtaining the image of the user associated with each of the locations.

Another example method includes the forgoing operations and further includes the operation of authenticating the user based on facial recognition.

Another example method includes the forgoing operations and further includes the operation of authenticating the user based on eye blink detection.

According to another aspect there is provided a platform. The platform may include a network interface to communicate with a secure content provider. The platform of this example may also include a liveliness-authentication agent to receive a security image from a user authentication system of the secure content provider. The platform of this example may further include a display element to display the security image to be viewed by a user of the platform. The platform of this example may further include a camera to image a corneal reflection of the user. The liveliness-authentication agent of this platform may further be configured to transmit the corneal reflection image to the user authentication system.

Another example platform includes the forgoing components and the liveliness-authentication agent is further to receive secure content from the secure content provider in response to the transmission of the corneal reflection image.

Another example platform includes the forgoing components and the platform is a smartphone, a laptop, a tablet, a notebook or an Ultrabook.

Another example platform includes the forgoing components and the display element is a touch screen display element.

According to another aspect there is provided a system. The system may include a means for generating a security image. The system of this example may also include a means for providing the security image for presentation to the user on a client system display element. The system of this example may further include a means for obtaining an image of the user from a camera of the client system. The system of this example may further include a means for extracting a corneal reflected image from the user image. The system of this example may further include a means for matching estimated features between the corneal reflected image and the security image. The system of this example may further include a means for verifying liveliness of the user based on the matching.

Another example system includes the forgoing components and further includes a means for providing secure content to the user in response to the verification.

Another example system includes the forgoing components and further includes a means for detecting an eye in the user image and means for extracting the corneal reflected image from a region of the user image encompassing the detected eye.

Another example system includes the forgoing components and the estimated features include patterns.

Another example system includes the forgoing components and the estimated features include colors.

Another example system includes the forgoing components and the corneal reflected image further includes a reflection of an object in the environment of the user, and the means for user liveliness verification further includes means for identifying the object.

Another example system includes the forgoing components and further includes a means for directing the user to sequentially view a plurality of locations of the display element; and means for obtaining the image of the user associated with each of the locations.

Another example system includes the forgoing components and further includes a means for authenticating the user based on facial recognition.

Another example system includes the forgoing components and further includes a means for authenticating the user based on eye blink detection.

According to another aspect there is provided at least one computer-readable storage medium having instructions stored thereon which when executed by a processor, cause the processor to perform the operations of the method as described in any of the examples above.

According to another aspect there is provided an apparatus including means to perform a method as described in any of the examples above.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1-25. (canceled)

26. A system for verification of user liveliness, said system comprising:
a security image generation module to provide a security image for presentation to said user on a client system display element;
a corneal reflection analysis module to estimate features of a corneal reflected image, said corneal reflected image extracted from an image of said user obtained by a camera of said client system; and
said corneal reflection analysis module further to verify liveliness of said user based on a match between said corneal reflected image and said security image, said match based on said estimated features.

27. The system of claim 26, further comprising a secure content provisioning module to provide secure content to said user in response to said verification.

28. The system of claim 26, wherein said corneal reflection analysis module further comprises an eye detection module to detect an eye in said user image.

29. The system of claim 28, wherein said corneal reflection analysis module further comprises an eye region image extraction module to extract a region of said user image encompassing said detected eye, said extracted region comprising said corneal reflected image.

30. The system of claim 26, wherein said estimated features comprise patterns.

31. The system of claim 26, wherein said estimated features comprise colors.

32. The system of claim 26, wherein said corneal reflected image further comprises a reflection of an object in the environment of said user, and said user liveliness verification further comprises identification of said object.

33. The system of claim 26, further comprising a user authentication system to perform facial recognition.

34. The system of claim 26, further comprising a user authentication system to perform eye blink detection.

35. A computer-readable storage medium having instructions stored thereon which when executed by a processor result in the following operations for verification of user liveliness, said operations comprising:
generating a security image;
providing said security image for presentation to said user on a client system display element;
obtaining an image of said user from a camera of said client system;
extracting a corneal reflected image from said user image;
matching estimated features between said corneal reflected image and said security image; and
verifying liveliness of said user based on said matching.

36. The computer-readable storage medium of claim 35, further comprising the operation of providing secure content to said user in response to said verification.

37. The computer-readable storage medium of claim 35, further comprising the operations of detecting an eye in said user image and extracting said corneal reflected image from a region of said user image encompassing said detected eye.

38. The computer-readable storage medium of claim 35, wherein said estimated features comprise patterns.

39. The computer-readable storage medium of claim 35, wherein said estimated features comprise colors.

40. The computer-readable storage medium of claim 35, wherein said corneal reflected image further comprises a reflection of an object in the environment of said user, and said user liveliness verification further comprises the operation of identifying said object.

41. The computer-readable storage medium of claim 35, further comprising the operation of authenticating said user based on facial recognition.

42. The computer-readable storage medium of claim 35, further comprising the operation of authenticating said user based on eye blink detection.

43. The computer-readable storage medium of claim 35, further comprising the operation of directing said user to sequentially view a plurality of locations of said display element; and obtaining said image of said user associated with each of said locations.

44. A platform comprising:
a network interface to communicate with a secure content provider;
an liveliness-authentication agent to receive a security image from a user authentication system of said secure content provider;
a display element to display said security image to be viewed by a user of said platform;
a camera to image a corneal reflection of said user; and
said liveliness-authentication agent further to transmit said corneal reflection image to said user authentication system.

45. The platform of claim 44, wherein said liveliness-authentication agent is further to receive secure content from said secure content provider in response to said transmission of said corneal reflection image.

46. The platform of claim 44, wherein said platform is a smartphone, a laptop, a tablet, a notebook or an Ultrabook.

47. The platform of claim 44, wherein said display element is a touch screen display element.
